(19) United States
(12) Patent Application Publication
(10) Pub. No.: US 2025/0158949 A1
(43) Pub. Date: May 15, 2025

(54) COMMUNICATION SYSTEM, COMMUNICATION CONTROL DEVICE, SERVER, COMMUNICATION CONTROL METHOD, AND RECORDING MEDIUM

(71) Applicant: Mitsubishi Electric Corporation, Tokyo (JP)

(72) Inventors: Takamitsu YAMADA, Tokyo (JP); Takayoshi TONOMURA, Tokyo (JP); Kentaro SAWA, Tokyo (JP); Toshiyasu HIGUMA, Tokyo (JP)

(21) Appl. No.: 18/837,921

(22) PCT Filed: Mar. 25, 2022
(86) PCT No.: PCT/JP2022/014300

§ 371 Date: Aug. 13, 2024

(51) Int. Cl. H04L 51/212; H04L 12/28

(52) U.S. Cl. CPC H04L 51/212; H04L 12/2803

(57) ABSTRACT

A communication control device in a communication system includes a filter updater that updates filtering information, and a transmission determiner that determines whether to transmit an appliance message to a cloud server based on the filtering information. The cloud server in the communication system includes a combination determiner that determines whether an appliance information storage stores a combination of IP address information included in an appliance identification information response transmitted from the communication control device and MAC address information of a communication control device being a transmission source of the appliance identification information response, and a filter update requester that transmits, to the communication control device being the transmission source of the appliance identification information response, a filter update request to request an update of the filtering information to filter the appliance message including the IP address information stored in the appliance information storage.

### TECHNICAL FIELD

The present disclosure relates to a communication system, a communication control device, a server, a communication control method, and a program.

### BACKGROUND ART

A known monitoring system for controlling home appliances includes a communication adapter connected to a home appliance and a controller that communicates with the communication adapter (see, for example, Patent Literature 1). In this monitoring system for controlling home appliances, the controller manages a correspondence table including information indicating a connection relationship between the communication adapter and the home appliance. When receiving an activation notification transmitted from the communication adapter upon activation of the communication adapter, the controller requests identification information of the home appliance connected to the communication adapter and updates the correspondence table based on the identification information transmitted from the communication adapter in response to the request.

### CITATION LIST

### Patent Literature

Patent Literature 1: Unexamined Japanese Patent Application Publication No. 2015-46824

### SUMMARY OF INVENTION

### Technical Problem

In the monitoring system for controlling home appliances described in Patent Literature 1, the communication adapter is connected to a local area network, and a controller controls the home appliance through a gateway connected to the local area network and through a wide area network. Such a system is to reduce traffic between the gateway and the controller.

Under such circumstances, an objective of the present disclosure is to provide a communication system, a communication control device, a server, a communication control method, and a program that can reduce network traffic.

### Solution to Problem

To achieve the above objective, a communication system according to an aspect of the present disclosure includes a server and a plurality of communication control devices connected to a local area network to which an appliance is connected and connected to the server through a wide area network. The plurality of communication control devices transmit, to the server through the wide area network, an appliance message generated by the appliance and acquired through the local area network. Each of the plurality of communication control devices includes a filter storage to store filtering information to filter the appliance message for transmission to the server based on appliance identification information identifying the appliance being a transmission source of the appliance message, a filter updater to update the filtering information based on a filter update request transmitted from the server to request an update of the filtering information, a message acquirer to acquire the appliance message transmitted from the appliance, and a transmission determiner to determine whether to transmit the appliance message to the server based on the filtering information. The server includes an appliance information storage to store, in a manner associated with each other, the appliance identification information and device identification information identifying a communication control device of the plurality of communication control devices, a combination determiner to determine whether the appliance information storage stores a combination of the appliance message including the appliance identification information transmitted from one communication control device of the plurality of communication control devices and the device identification information of the one communication control device being a transmission source of the appliance message, an appliance information updater to cause the appliance information storage to newly store first appliance identification information included in the combination determined as not being stored in the appliance information storage in a manner associated with the device identification information of a transmission source of a first appliance message including the first appliance identification information, and a filter update requester to transmit, to a communication control device of the plurality of communication control devices being a transmission source of a second appliance message, a filter update request to request an update of the filtering information to filter the second appliance message including second appliance identification information included in the combination determined as being stored in the appliance information storage.

### Advantageous Effects of Invention

In the communication system according to the above aspect of the present disclosure, the appliance message is transmitted from the appliance to the server through any single control device of the plurality of communication control devices to reduce the likelihood of the same appliance message output to the wide area network through the communication control devices. The communication system thus can reduce the traffic on the wide area network.

### BRIEF DESCRIPTION OF DRAWINGS

FIG. 1 is a schematic diagram of a communication system according to an embodiment of the present disclosure;

FIG. 2 is a block diagram of the communication system according to the embodiment, illustrating the hardware configuration;

FIG. 3 is a functional block diagram of the communication system according to the embodiment;

FIG. 4 is a table illustrating example information stored in a device information storage in a cloud server according to the embodiment;

FIG. 5 is a sequence diagram illustrating an operation of the communication system according to the embodiment;

FIG. 6 is a sequence diagram illustrating the operation of the communication system according to the embodiment;

FIG. 7 is a sequence diagram illustrating the operation of the communication system according to the embodiment;

FIG. 8 is a sequence diagram illustrating the operation of the communication system according to the embodiment;

FIG. 9 is a sequence diagram illustrating the operation of the communication system according to the embodiment;

FIG. 10 is a flowchart of an example communication control process performed by a communication control device according to the embodiment;

FIG. 11 is a flowchart of an example device control process performed by the cloud server according to the embodiment; and

FIG. 12 is a flowchart of the example device control process performed by the cloud server according to the embodiment

### DESCRIPTION OF EMBODIMENTS

A communication system according to an embodiment of the present disclosure is described below with reference to the accompanying drawings. The communication system according to the present embodiment includes a server and multiple communication control devices connected to a local area network to which an appliance is connected and connected to the server through a wide area network. The multiple communication control devices transmit, to the server through the wide area network, an appliance message generated by the appliance and acquired through the local area network. Each of the communication control devices includes a filter storage to store filtering information to filter the appliance message for transmission to the server based on appliance identification information identifying the appliance that is a transmission source of the appliance message, a filter updater to update the filtering information based on a filter update request transmitted from the server to request an update of the filtering information, a message acquirer to acquire an appliance message transmitted from the appliance, and a transmission determiner to determine whether to transmit the appliance message to the server based on the filtering information. The server includes an appliance information storage to store, in a manner associated with each other, the appliance identification information and device identification information identifying a communication control device of the multiple communication control devices, a combination determiner to determine whether the appliance information storage stores a combination of the appliance message including the appliance identification information transmitted from one communication control device of the multiple communication control devices and the device identification information of the one communication control device that is the transmission source of the appliance message, an appliance information updater to cause the appliance information storage to newly store first appliance identification information included in the combination determined as not being stored in the appliance information storage in a manner associated with the device identification information of a transmission source of a first appliance message including the first appliance identification information, and a filter update requester to transmit, to a communication control device of the multiple communication control devices that is a transmission source of a second appliance message, a filter update request to request an update of the filtering information to filter the second appliance message including second appliance identification information included in the combination determined as being stored in the appliance information storage.

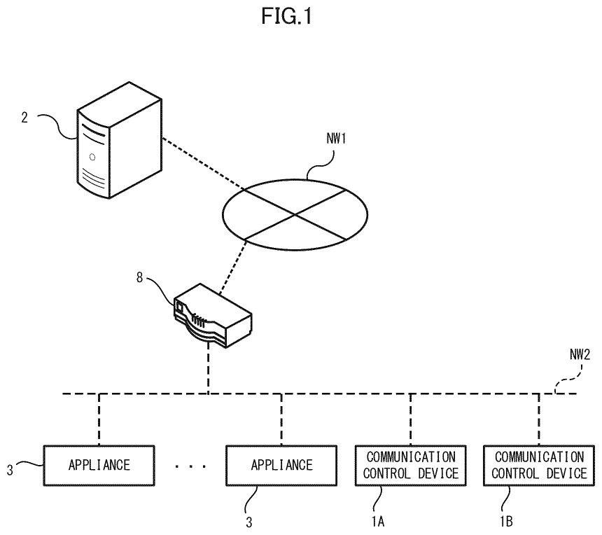

As illustrated in FIG. 1, for example, the communication system according to the present embodiment includes a cloud server 2, appliances 3 installed in a house, and communication control devices 1A and 1B that each transmit an appliance message generated by an appliance 3 to the cloud server 2. The appliances 3 and the communication control devices 1A and 1B can communicate with one another through a local area network NW2 such as a wireless local area network (LAN). The cloud server 2 can perform communication through a wide area network NW1 such as the Internet, and through a broadband router (hereafter referred to as BBR) 8. An appliance 3 is, for example, an air conditioner including a wireless module, and communicates with the BBR 8 and the communication control devices 1A and 1B through the local area network NW2.

The appliance 3 that is, for example, an air conditioner including a wireless module communicates with the communication control devices 1A and 1B through the local area network NW2 using, for example, communication middleware such as ECHONET Lite (registered trademark). When acquiring an appliance information request transmitted from the communication control device 1A or 1B to request transmission of appliance state information indicating the state of the appliance 3 to the cloud server 2, the appliance 3 generates the appliance state information including state parameter information indicating the state of the appliance 3 and transmits the information to the communication control devices 1A and 1B. The appliance 3 further generates, when connected to the local area network NW2 for the first time, a network participation notification notifying that the appliance 3 is connected to the local area network NW2, and transmits the notification to the communication control devices 1A and 1B. The network participation notification includes, for example, media access control (MAC) address information and IP address information of the appliance 3 and corresponds to, for example, an instance list notification in the ECHONET Lite (registered trademark) specification. The appliance 3 operates based on control information transmitted from the communication control device 1A or 1B.

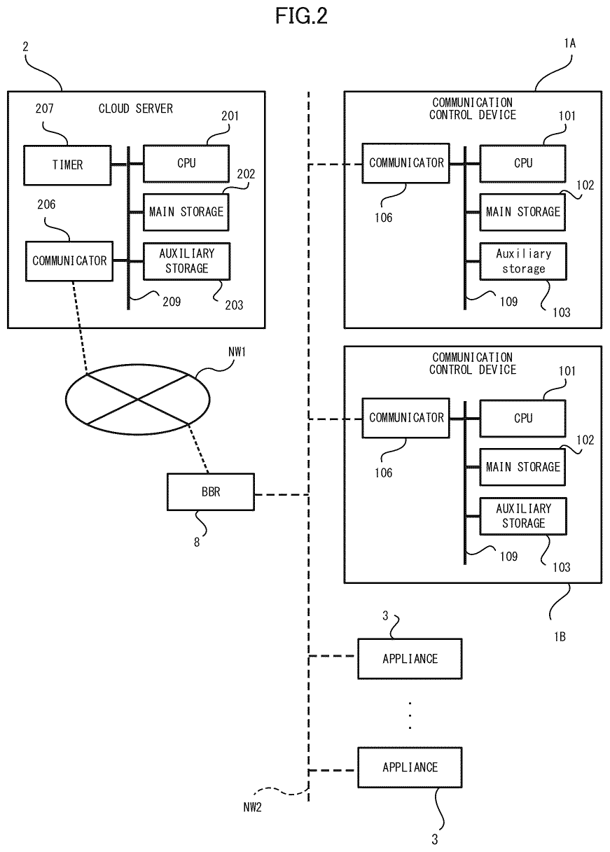

The communication control devices 1A and 1B each transmit the appliance message generated by an appliance 3 to the cloud server 2 through the wide area network NW1. As illustrated in FIG. 2, the communication control devices 1A and 1B each include a central processing unit (CPU) 101, a main storage 102, an auxiliary storage 103, a communicator 106, and a bus 109 that connects the components. The main storage 102 is a volatile memory such as a random-access memory (RAM) used as a work area for the CPU 101. The auxiliary storage 103 includes a nonvolatile memory such as a semiconductor memory, functions as a read-only memory (ROM) or a storage, and stores programs to implement various functions of the communication control device 1A or 1B. The communicator 106 includes, for example, a wireless module and performs wireless communication between the appliances 3 and the BBR 8.

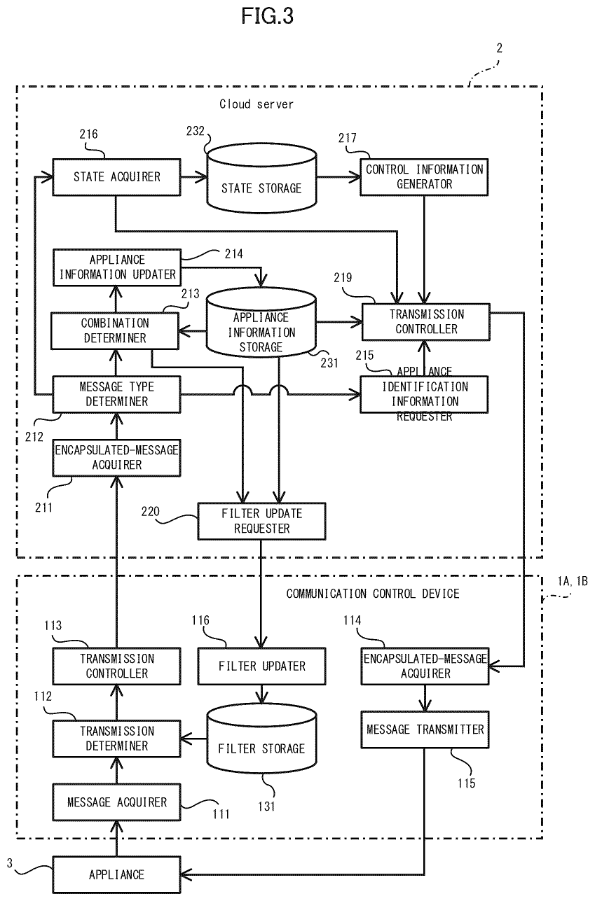

In each of the communication control devices 1A and 1B, the CPU 101 reads the programs stored in the auxiliary storage 103 into the main storage 102 and executes the programs to function as a message acquirer 111, a transmission determiner 112, a transmission controller 113, an encapsulated-message acquirer 114, a message transmitter 115, and a filter updater 116 as illustrated in FIG. 3. The auxiliary storage 103 illustrated in FIG. 2 includes a filter storage 131 as illustrated in FIG. 3. The filter storage 131 stores filtering information to filter the appliance message for transmission to the cloud server 2 based on address information indicating an address assigned to the appliance 3 that is the transmission source of the appliance message. The filtering information includes IP address information indicating the IP address of an appliance 3 that is the transmission source of the appliance message to be discarded without being transmitted to the cloud server 2, and identification number indicating an identification number unique to the appliance 3.

The message acquirer 111 acquires the appliance message transmitted from the appliance 3 and provides, to the transmission determiner 112, the acquired appliance message and IP address information of the transmission source of the appliance message. This appliance message is a network participation notification notifying that the appliance 3 is newly connected to the local area network NW2, an appliance identification information response corresponding to an appliance identification information request (described later) including identification number identifying the appliance 3 in the application layer, or the appliance state information described above. The network participation notification is, for example, an instance list notification message multicast from the appliance 3 when the appliance 3 as a node in a communication protocol for the ECHONET Lite (registered trademark) specification is newly activated. The identification number is, for example, a 16-byte identification number uniquely assigned to the appliance 3 in the ECHONET Lite (registered trademark) specification.

The transmission determiner 112 determines whether the appliance message provided from the message acquirer 111 is a filtering target. More specifically, the transmission determiner 112 determines whether the IP address indicated by the IP address information provided from, together with the appliance message, the message acquirer 111 is included in the IP addresses indicated by the filtering information stored in the filter storage 131. When the IP address indicated by the IP address information provided from the message acquirer 111 together with the appliance message is included in the IP addresses indicated by the filtering information, the transmission determiner 112 determines that the provided appliance message is a filtering target. The transmission determiner 112 provides, to the transmission controller 113, the appliance message and determination result information indicating the determination result.

The transmission controller 113 controls transmission of the appliance message to the cloud server 2. The transmission controller 113 transmits, to the cloud server 2, the appliance message determined as not being a filtering target by the transmission determiner 112. In contrast, the transmission controller 113 discards the appliance message determined as being a filtering target by the transmission determiner 112 to avoid transmission of the appliance message to the cloud server. The transmission controller 113 adds the MAC address information of the communication control device 1A or 1B to the appliance message and encapsulates the appliance message. The transmission controller 113 then adds header information to specify the cloud server 2 as a destination to the appliance message and transmits the appliance message to the cloud server 2. The header information includes, for example, domain name information of the cloud server 2.

Upon acquiring various items of information transmitted to the communication control device 1A or 1B as a destination from the cloud server 2, the encapsulated-message acquirer 114 removes the header information from the acquired information and de-encapsulates the information to extract information including the MAC address information of the appliance 3 and the MAC address information of the communication control device 1A or 1B. The various items of information include the appliance identification information request to request the appliance 3 to transmit the appliance identification information response including the identification number, the appliance state request to request the appliance 3 to transmit the appliance state information indicating the state of the appliance 3, and control information to control the appliance 3. The encapsulated-message acquirer 114 then provides the extracted various items of information to the message transmitter 115. The message transmitter 115 transmits the provided various items of information to the appliance 3 based on the MAC address information of the appliance 3 included in the various items of information provided from the encapsulated-message acquirer 114.

The filter updater 116 updates filtering information stored in the filter storage 131 based on the filter update request transmitted from the cloud server 2 to request an update of the filtering information.

Referring back to FIG. 2, the cloud server 2 includes a CPU 201, a main storage 202, an auxiliary storage 203, a communicator 206, a timer 207, and a bus 209 that connects the components. The CPU 201 is, for example, a multi-core processor. The main storage 202 is a volatile memory used as a work area for the CPU 201. The auxiliary storage 203 includes a nonvolatile memory, functions as a ROM and a storage, and stores programs to implement various functions of the cloud server 2. The communicator 206 communicates with the communication control devices 1A and 1B through the wide area network NW1 and the BBR 8. The timer 207 is, for example, a software timer and clocks time elapsed after the start of a period to acquire the appliance state information described above.

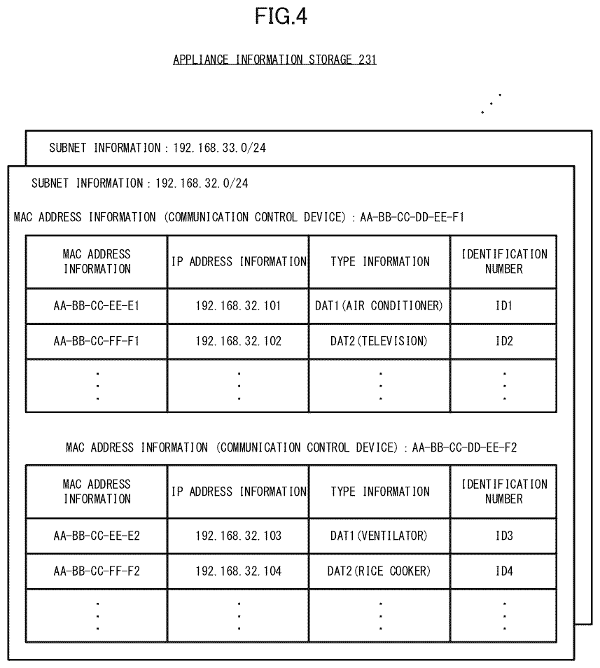

In the cloud server 2, the CPU 201 reads the programs stored in the auxiliary storage 203 into the main storage 202 and executes the programs to function as an encapsulated-message acquirer 211, a message type determiner 212, a combination determiner 213, an appliance information updater 214, an appliance identification information requester 215, a state acquirer 216, a control information generator 217, a transmission controller 219, and a filter update requester 220 as illustrated in FIG. 3. The auxiliary storage 203 illustrated in FIG. 2 includes an appliance information storage 231 and a state storage 232 as illustrated in FIG. 3. The appliance information storage 231 stores, in a manner associated with the device identification information identifying the communication control device 1A or 1B, at least a combination of the identification number identifying the appliance 3 in the application layer, the MAC address information, and the IP address information. The identification number, the MAC address information, and the IP address information each correspond to the appliance identification information identifying the appliance 3. As illustrated in, for example, FIG. 4, the appliance information storage 231 stores the MAC address information and the IP address information of the appliances 3 connected to the local area network NW2 in a manner associated with the MAC address information that is the device identification information of the communication control device 1A or 1B connected to the local area network NW2. The appliance information storage 231 also stores, for each item of MAC address information of the communication control devices 1A and 1B, a combination of type information indicating the type of the appliance 3 and the identification number described above in a manner associated with a combination of the MAC address information and the IP address information of the appliance 3. In the example illustrated in FIG. 4, two communication control devices 1A and 1B having the respective MAC addresses of AA-BB-CC-DD-EE-F1 and AA-BB-CC-DD-EE-F2 are connected to the local area network NW2 indicated with subnet information of 192.168.32.0/24. The appliance information storage 231 stores, for each appliance 3, a combination of the IP address information, the MAC address information, the type information, and the identification number in a manner associated with the device identification information of either the communication control device 1A or the communication control device 1B.

Referring back to FIG. 3, the state storage 232 stores, in a manner associated with the IP address information and the MAC address information of the appliance 3, the appliance state information indicating the state of the appliance 3.

Upon acquiring the various items of information transmitted from the communication control device 1A or 1B, the encapsulated-message acquirer 211 de-encapsulates the acquired various items of information, removes the header information, and extracts the appliance message including the MAC address information and the IP address information of the appliance 3. The encapsulated-message acquirer 211 provides the extracted appliance message to the message type determiner 212.

The message type determiner 212 determines whether the appliance message provided from the encapsulated-message acquirer 211 is the network participation notification described above, the appliance identification information response, or the appliance state information. When determining that the appliance message is the network participation notification, the message type determiner 212 provides the network participation notification to the appliance identification information requester 215. When determining that the appliance message provided from the encapsulated-message acquirer 211 is the appliance identification information response described above, the message type determiner 212 provides the appliance identification information response to the combination determiner 213. When determining that the appliance message is the appliance state information, the message type determiner 212 provides the appliance state information to the state acquirer 216.

The combination determiner 213 determines whether the appliance information storage 231 stores a combination of the IP address information of the appliance 3 included in the appliance identification information response transmitted from the communication control device 1A or 1B and the MAC address information of the communication control device 1A or 1B that is the transmission source of the appliance identification information response. The combination determiner 213 determines that the combination including the IP address information of the appliance 3 is not stored when the combination of the IP address information of the appliance 3 and the MAC address information of the communication control device 1A or 1B that is the transmission source of the appliance identification information response differs from the combinations of the IP address information and the MAC information of the communication control device 1A or 1B stored in the appliance information storage 231, or when the appliance information storage 231 does not store the IP address information of the appliance 3 included in the device identification information. The combination determiner 213 provides the determination result information indicating the result of the determination to the appliance information updater 214.

The appliance information updater 214 causes the appliance information storage 231 to newly store, based on the determination result information provided from the combination determiner 213, the IP address information included in the combination of the IP address information of the appliance 3 and the MAC address information of the communication control device 1A or 1B determined as not being stored in the appliance information storage 231 in a manner associated with the MAC address information of the communication control device 1A or 1B that is the transmission source of the appliance message including the IP address information. The appliance information updater 214 also causes the appliance information storage 231 to store, in a manner associated with the IP address information, the MAC address information and the identification number of the appliance 3 included in, together with the IP address information, the appliance identification information response provided from the combination determiner 213.

Upon receiving the network participation notification from the message type determiner 212, the appliance identification information requester 215 generates the appliance identification information request to request the appliance 3 to transmit the appliance identification information response, and provides the generated appliance identification information request to the transmission controller 219.

The state acquirer 216 transmits, to the appliance 3, the appliance state request to request the appliance 3 to transmit the appliance state information, and acquires the appliance state information transmitted from the appliance 3. More specifically, every time the predetermined period to determine the device state starts, the state acquirer 216 generates the appliance state request, and provides the generated appliance state request to the transmission controller 219. Upon receiving the appliance state information from the message type determiner 212, the state acquirer 216 updates the appliance state information stored in the state storage 232 using the received appliance state information.

The control information generator 217 refers to the appliance state information stored in the state storage 232 and determines, based on the state of the appliance 3 indicated by the appliance state information, occurrence of a control event for which control settings of the appliance 3 are to be changed. When determining the occurrence of a control event, the control information generator 217 generates control information to change the control settings of the appliance 3 and provides the generated control information to the transmission controller 219.

Upon receiving various items of information from the appliance identification information requester 215, the state acquirer 216, and the control information generator 217, the transmission controller 219 identifies the communication control device 1A or 1B that is a destination based on the received various items of information. The transmission controller 219 identifies the MAC address information and the IP address information of the communication control device 1A or 1B associated with the combination of the MAC address information and the IP address information of the appliance 3 to which the control information stored in the appliance information storage 231 is to be transmitted as a destination. The transmission controller 219 encapsulates the received various items of information and adds the header information to specify the identified communication control device 1A or 1B as the destination. The header information includes the IP address information and the MAC address information of the identified communication control device 1A or 1B.

Based on the determination result information provided from the combination determiner 213, the filter update requester 220 transmits, to the communication control device 1A or 1B that is the transmission source of the appliance identification information response, the filter update request to request an update of the filtering information that filters the appliance message including the IP address information included in a combination of the IP address information of the appliance 3 determined as being stored in the appliance information storage 231 and the MAC address information of the communication control device 1A or 1B.

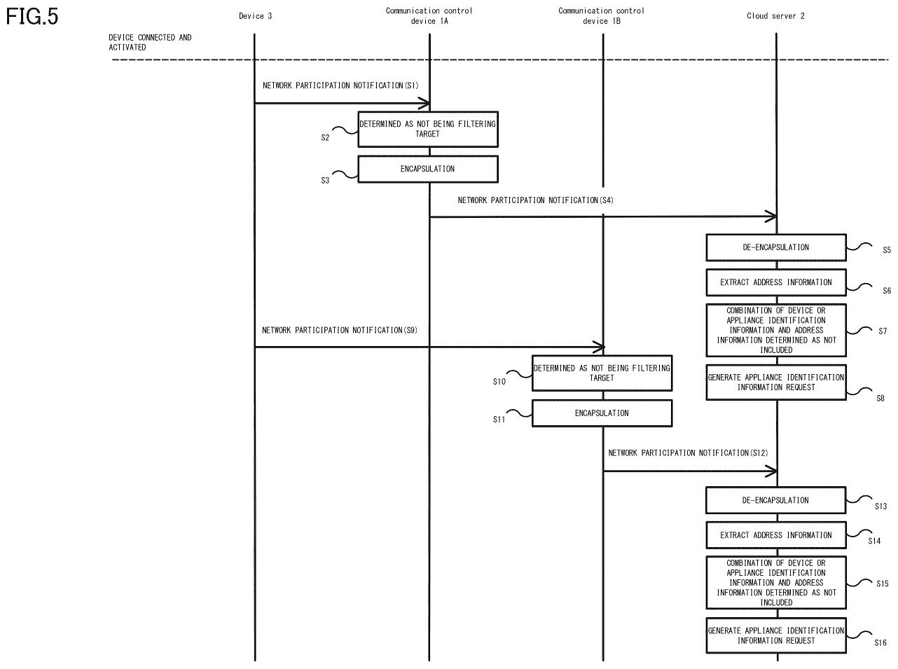

An operation of the communication system according to the present embodiment is now described with reference to FIGS. 5 to 9. In this example, the communication control devices 1A and 1B and the cloud server 2 have undergone the processing for establishing connection, and each have acquired IP address information of the others. In this example, two communication control devices 1A and 1B are connected to the local area network NW2. As illustrated in FIG. 5, a user newly connects an appliance 3 to the local area network NW2 and activates the appliance 3 first. In this case, the appliance 3 transmits, to the communication control device 1A, a network participation notification notifying that the appliance 3 is newly connected to the local area network NW2 (step S1).

Upon acquiring the network participation notification, the communication control device 1A determines, with the IP address information of the appliance 3 not included in the filtering information stored in the filter storage 131, that the acquired network participation notification is not a filtering target (step S2). The communication control device 1A then performs encapsulation to add, to the network participation notification, the MAC address information of the communication control device 1A and the header information to specify the cloud server 2 as a destination (step S3). The encapsulated network participation notification is transmitted from the communication control device 1A to the cloud server 2 (step S4). Upon acquiring the network participation notification transmitted from the communication control device 1A, the cloud server 2 performs de-encapsulation to remove, from the acquired network participation notification, the header information specifying the cloud server 2 as the destination (step S5), and extracts the MAC address information and the IP address information of the appliance 3 and the MAC address information of the communication control device 1A (step S6). The cloud server 2 then determines, with the appliance information storage 231 not storing the IP address information of the appliance 3 in a manner associated with the device identification information of the communication control device 1A, that a combination of the extracted IP address information of the appliance 3 and the extracted device identification information of the communication control device 1A is not included in the combinations of device identification information and IP address information stored in the appliance information storage 231 (step S7). The cloud server 2 then generates the appliance identification information request including the extracted MAC address information and the extracted IP address information of the appliance 3 (step S8).

The network participation notification described above is also transmitted from the appliance 3 to the communication control device 1B (step S9). Upon acquiring the network participation notification, the communication control device 1B determines, with the IP address information of the appliance 3 not included in the filtering information stored in the filter storage 131, that the acquired network participation notification is not a filtering target (step S10). Similarly to the communication control device 1A, the communication control device 1B then performs encapsulation to add, to the network participation notification, the MAC address information of the communication control device 1B and the header information to specify the cloud server 2 as a destination (step S11). The encapsulated network participation notification is then transmitted from the communication control device 1B to the cloud server 2 (step S12). Upon acquiring the network participation notification transmitted from the communication control device 1B, the cloud server 2 performs de-encapsulation to remove, from the acquired network participation notification, the header information specifying the cloud server 2 as the destination (step S13). The cloud server 2 then extracts the MAC address information and the IP address information of the appliance 3 and the MAC address information of the communication control device 1B (step S14). Subsequently, the cloud server 2 determines, with the appliance information storage 231 not storing the IP address information of the appliance 3 in a manner associated with the device identification information of the communication control device 1B, that a combination of the extracted IP address information of the appliance 3 and the extracted device identification information of the communication control device 1B is not included in the combinations of device identification information and IP address information stored in the appliance information storage 231 (step S15). The cloud server 2 then generates the appliance identification information request including the extracted MAC address information and the extracted IP address information of the appliance 3 (step S16).

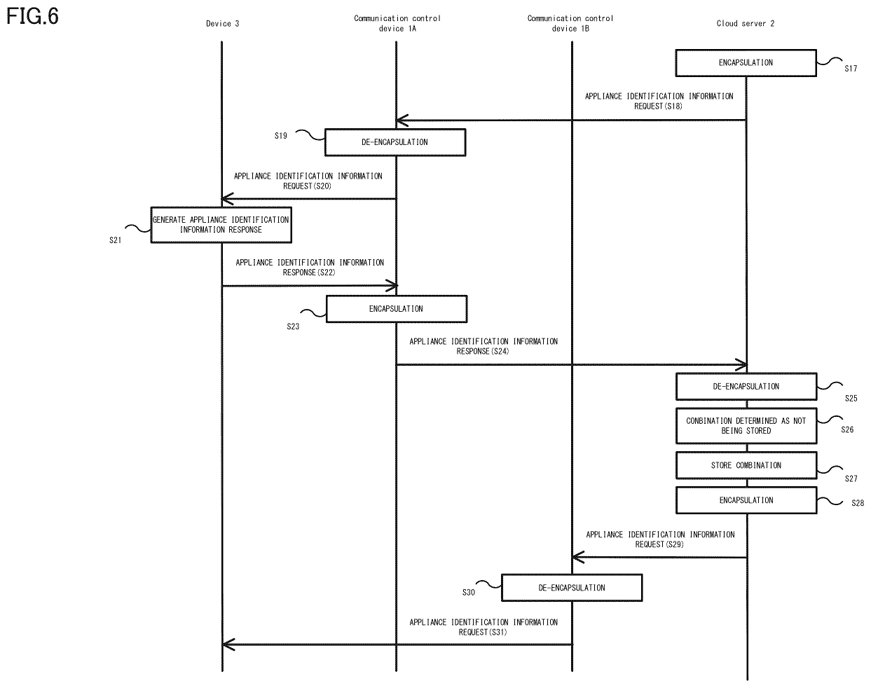

Subsequently, as illustrated in FIG. 6, the cloud server 2 performs encapsulation to add the header information to the generated appliance identification information request to specify, as a destination, the communication control device 1A that is the transmission source of the network participation notification (step S17). The encapsulated appliance identification information request is then transmitted from the cloud server 2 to the communication control device 1A (step S18). Upon acquiring the appliance identification information request transmitted from the cloud server 2, the communication control device 1A performs de-encapsulation to remove, from the acquired appliance identification information request, the header information specifying the communication control device 1A described above as the destination (step S19). The appliance identification information request is then transmitted from the communication control device 1A to the appliance 3 based on the MAC address information and the IP address information of the appliance 3 included in the appliance identification information request (step S20).

Upon acquiring the appliance identification information request, the appliance 3 accordingly generates the appliance identification information response including the identification number of the appliance 3 (step S21). The generated appliance identification information response is then transmitted from the appliance 3 to the communication control device 1A (step S22). Upon acquiring the appliance identification information response, the communication control device 1A performs encapsulation as in step S3 described above (step S23). The encapsulated appliance identification information response is then transmitted from the communication control device 1A to the cloud server 2 (step S24). Upon acquiring the appliance identification information response transmitted from the communication control device 1A, the cloud server 2 de-encapsulates, in the above manner, the acquired appliance identification information response (step S25). In this example, the cloud server 2 determines that the appliance information storage 231 does not store, in a manner associated with the device identification information of the communication control device 1A, a combination of the identification number included in the appliance identification information response and the IP address information and the MAC address information assigned to the appliance 3 that is the transmission source of the appliance identification information response (step S26). In this case, the cloud server 2 causes the appliance information storage 231 to store, in a manner associated with the device identification information of the communication control device 1A, the combination of the identification number included in the acquired appliance identification information response and the IP address information and the MAC address information assigned to the appliance 3 that is the transmission source of the appliance identification information response (step S27).

The cloud server 2 also performs encapsulation to add, to the generated appliance identification information request, the header information to specify, as a destination, the communication control device 1B that is the transmission source of the network participation notification (step S28). The encapsulated appliance identification information request is then transmitted from the cloud server 2 to the communication control device 1B (step S29). Upon acquiring the appliance identification information request transmitted from the cloud server 2, the communication control device 1B performs de-encapsulation to remove, from the acquired appliance identification information request, the header information specifying the communication control device 1B described above as the destination (step S30). The appliance identification information request is then transmitted from the communication control device 1B to the appliance 3 based on the MAC address information and the IP address information of the appliance 3 included in the appliance identification information request (step S31).

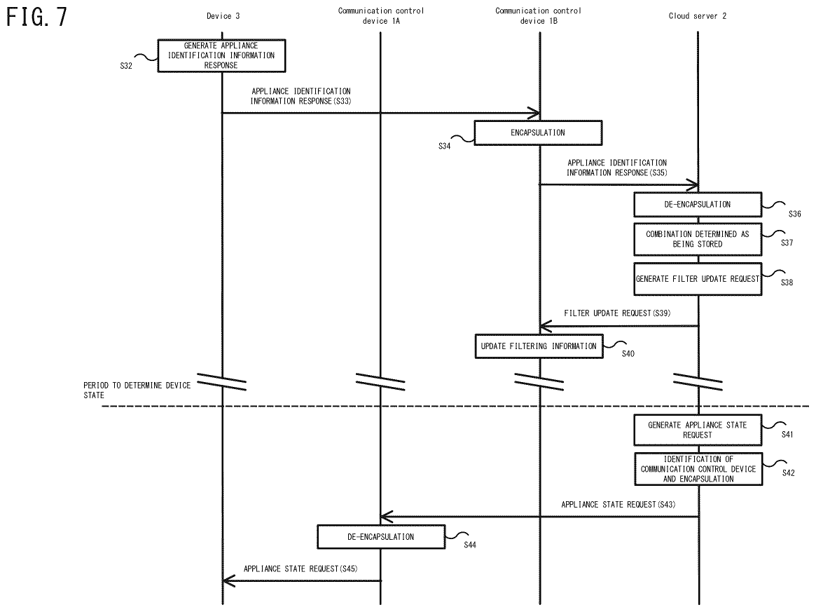

As illustrated in FIG. 7, upon acquiring the appliance identification information request, the appliance 3 accordingly generates an appliance identification information response including the identification number and the type information of the appliance 3 (step S32). The generated appliance identification information response is then transmitted from the appliance 3 to the communication control device 1B (step S33). Upon acquiring the appliance identification information response, the communication control device 1B performs encapsulation as in step S11 described above (step S34). The encapsulated appliance identification information response is then transmitted from the communication control device 1B to the cloud server 2 (step S35). Upon acquiring the appliance identification information response transmitted from the communication control device 1B, the cloud server 2 de-encapsulates, in the above manner, the acquired appliance identification information response (step S36). In this example, the cloud server 2 determines that the appliance information storage 231 stores, in a manner associated with the device identification information of the communication control device 1A, the combination of the identification number and the type information included in the appliance identification information response and the IP address information and the MAC address information assigned to the appliance 3 that is the transmission source of the appliance identification information response (step S37). In this case, the cloud server 2 generates the filter update request including the IP address information assigned to the appliance 3 that is the transmission source of the appliance identification information response and included in the acquired appliance identification information response (step S38). The generated filter update request is then transmitted from the cloud server 2 to the communication control device 1B that is the transmission source of the appliance identification information response (step S39). Upon acquiring the filter update request, the communication control device 1B updates the filtering information stored in the filter storage 131 by adding the IP address information included in the acquired filter update request (step S40).

In this example, the predetermined period to determine the device state then starts. In this case, the cloud server 2 generates the appliance state request to request the appliance 3 to transmit the appliance state information (step S41). The cloud server 2 then refers to the device identification information associated with the IP address information of the appliance 3 that is the destination of the appliance state request stored in the appliance information storage 231 to identify the communication control device (for example, the communication control device 1A) as a destination of the appliance state request. The cloud server 2 then performs encapsulation to add, to the appliance state request, the header information to specify the identified communication control device 1A as the destination (step S42). The encapsulated appliance state request is then transmitted from the cloud server 2 to the communication control device 1A (step S43). Upon acquiring the appliance state request transmitted from the cloud server 2, the communication control device 1A performs de-encapsulation to remove, from the acquired appliance state request, the header information specifying the communication control device LA described above as the destination (step S44). The appliance state information request is then transmitted from the communication control device 1A to the appliance 3 based on the MAC address information and the IP address information of the appliance 3 included in the appliance state information request (step S45).

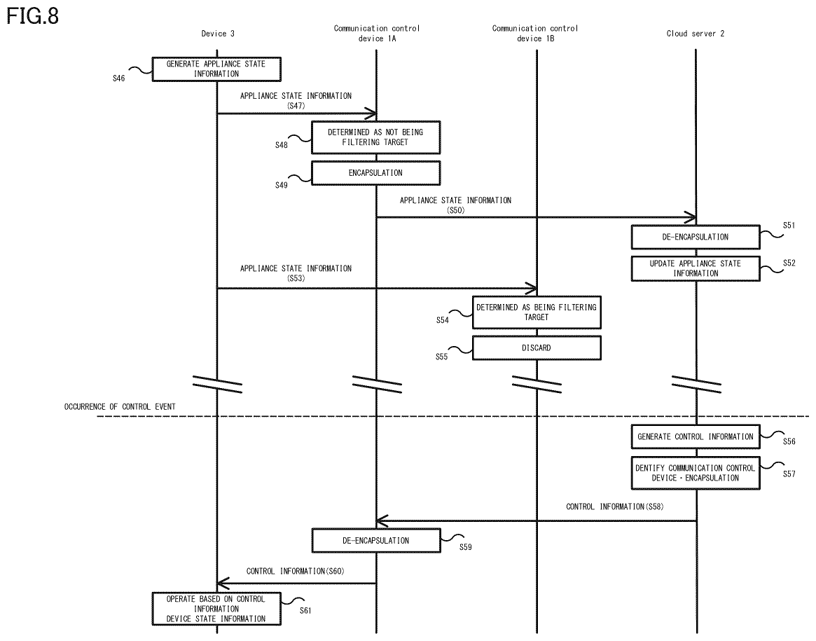

As illustrated in FIG. 8, upon acquiring the appliance state request, the appliance 3 accordingly generates the appliance state information indicating the state of the appliance 3 (step S46). The generated appliance state information is then transmitted from the appliance 3 to the communication control device 1A (step S47). In this example, the communication control device 1A refers to the IP address information included in the acquired appliance state information and determines that the appliance state information is not a filtering target (step S48). In this case, the communication control device 1A performs encapsulation to add, to the acquired appliance state information, the MAC address information of the communication control device 1A and the header information to specify the cloud server 2 as a destination (step S49). The encapsulated appliance state information is then transmitted from the communication control device 1A to the cloud server 2 (step S50). Upon acquiring the appliance state information transmitted from the communication control device 1A, the cloud server 2 de-encapsulates, in the above manner, the acquired appliance state information (step S51). The cloud server 2 then updates the appliance state information stored in the state storage 232 using the appliance state information (step S52).

In this example, the generated appliance state information is also transmitted from the appliance 3 to the communication control device 1B (step S53), and the communication control device 1B refers to the IP address information included in the acquired appliance state information and determines that the appliance state information is a filtering target (step S54). In this case, the communication control device 1B discards the acquired appliance state information (step SSS) to avoid transmission of the acquired appliance state information to the cloud server 2.

When a control event described above occurs, the cloud server 2 generates control information to change the control settings of the appliance 3 (step S56). The cloud server 2 then refers to the device identification information associated with the IP address information of the appliance 3 that is the destination of the appliance state request stored in the appliance information storage 231 to identify the communication control device (for example, the communication control device 1A) that is the destination of the control information. The cloud server 2 then performs encapsulation to add, to the appliance state request, the header information to specify the identified communication control device 1A as a destination (step S57). The encapsulated control information is then transmitted from the cloud server 2 to the communication control device 1A (step S58). Upon acquiring the control information transmitted from the cloud server 2, the communication control device 1A performs de-encapsulation to remove, from the acquired control information, the header information specifying the communication control device 1A described above as the destination (step S59). The control information is then transmitted from the communication control device 1A to the appliance 3 based on the MAC address information and the IP address information of the appliance 3 included in the control information (step S60). Upon acquiring the control information, the appliance 3 operates based on the acquired control information (step S61).

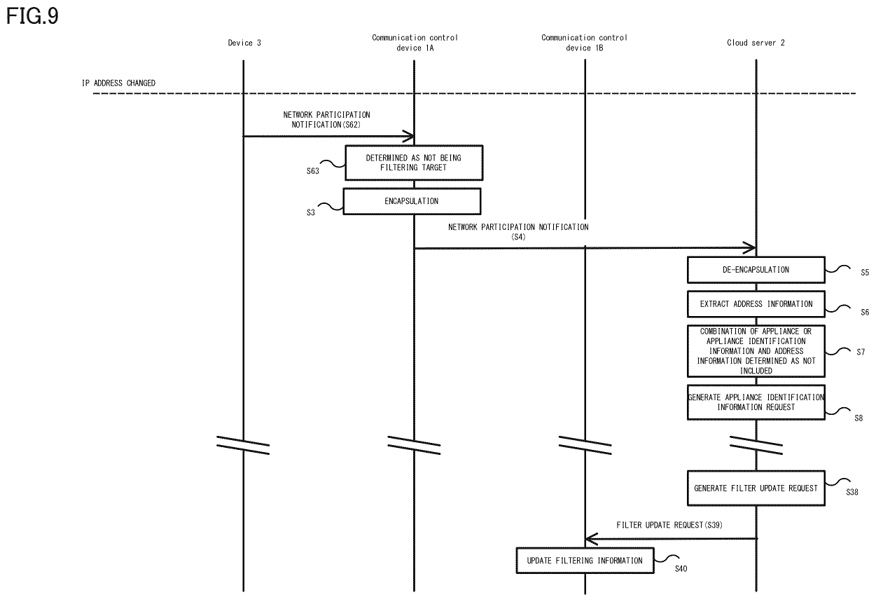

Subsequently, in this example, the IP address information of the appliance 3 is changed as illustrated in FIG. 9. In this case, the network participation notification is transmitted again from the appliance 3 to the communication control device 1A (step S62). Upon acquiring the network participation notification, the communication control device 1A determines, with the IP address information of the appliance 3 included in the filtering information stored in the filter storage 131 changed, that the acquired network participation notification is not a filtering target (step S63). Then, after a series of processes from steps S3 to S37 described above are performed, the cloud server 2 generates filter update request indicating a combination of the identification number of the appliance 3 stored in the appliance information storage 231 and the IP address information assigned to the appliance 3 (step S38). The generated filter update request is then transmitted from the cloud server 2 to the communication control device 1B that is the transmission source of the appliance identification information response (step S39). Upon acquiring the filter update request, the communication control device 1B updates the filtering information stored in the filter storage 131 based on the combination of the identification number and the IP address information included in the acquired filter update request (step S40).

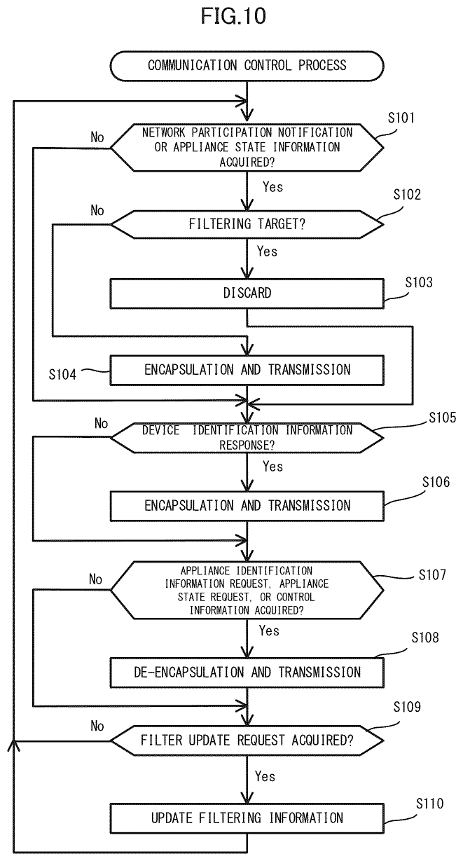

A communication control process performed by the communication control devices 1A and 1B according to the present embodiment is now described with reference to FIG. 10. This communication control process starts when, for example, a communication control device 1 is powered on and placed at a position connectable to the local area network NW2. The message acquirer 111 first determines whether the network participation notification or the appliance state information transmitted from the appliance 3 is acquired (step S101). When the message acquirer 111 determines that the network participation information or the appliance state information is not acquired (No in step S101), a process in step S105 (described later) is performed. When determining that the network participation notification or the appliance state information transmitted from the appliance 3 is acquired (Yes in step S101), the message acquirer 111 provides the acquired network participation notification or the appliance state information to the transmission determiner 112. The transmission determiner 112 then determines whether the network participation notification or the appliance state information is a filtering target (step S102). When the transmission determiner 112 determines that the network participation notification or the appliance state information is a filtering target (Yes in step S102), the transmission controller 113 discards the network participation notification or the appliance state information (step S103), and the process in step S105 (described later) is performed. When the transmission determiner 112 determines that the network participation notification or the appliance state information is not a filtering target (No in step S102), the transmission controller 113 performs encapsulation to add, to the network participation notification or the appliance state information, the MAC address information of the communication control device 1A or 1B and then add the header information to specify the cloud server 2 as a destination, and transmits the network participation notification or the appliance state information to the cloud server 2 (step S104).

The message acquirer 111 then determines whether the information transmitted from the appliance 3 is the appliance identification information response (step S105). When the message acquirer 111 determines that the information is not the appliance identification information response (No in step S105), the process in step S107 (described later) is performed. When the message acquirer 111 determines that the information is the appliance identification information response (Yes in step S105), the transmission controller 113 performs encapsulation to add, to the appliance identification information response, the MAC address information of the communication control device 1A or 1B and then add the header information to specify the cloud server 2 as a destination, and transmits the appliance identification information response to the cloud server 2 (step S106).

The encapsulated-message acquirer 114 then determines whether the encapsulated appliance identification information request, the appliance state request, or the control information having the communication control device 1A or 1B as the destination is acquired from the cloud server 2 (step S107). When the encapsulated- message acquirer 114 determines that none of the appliance identification information request, the appliance state request, or the control information transmitted is acquired from the cloud server 2 (No in step S107), a process in step S109 (described later) is performed. When determining that the appliance identification information request, the appliance state request, or the control information transmitted from the cloud server 2 is acquired (Yes in step S107), the encapsulated-message acquirer 114 provides the acquired appliance identification information request, the appliance state request, or the control information to the message transmitter 115. The message transmitter 115 then performs de-encapsulation to remove the header information specifying the communication control device 1A or 1B as a destination from the appliance identification information request, the appliance state request, or the control information provided from the encapsulated-message acquirer 114, and transmits the information to the appliance 3 (step S108).

The filter updater 116 then determines whether the filter update request is acquired from the cloud server 2 (step S109). When the filter updater 116 determines that the filter update request is not acquired (No in step S109), the process in step S101 is performed again. When determining that the filter update request is acquired (Yes in step S109), the filter updater 116 updates the filtering information stored in the filter storage 131 based on the IP address information and the identification number included in the acquired filter update request (step S110). The process in step S101 is then performed again.

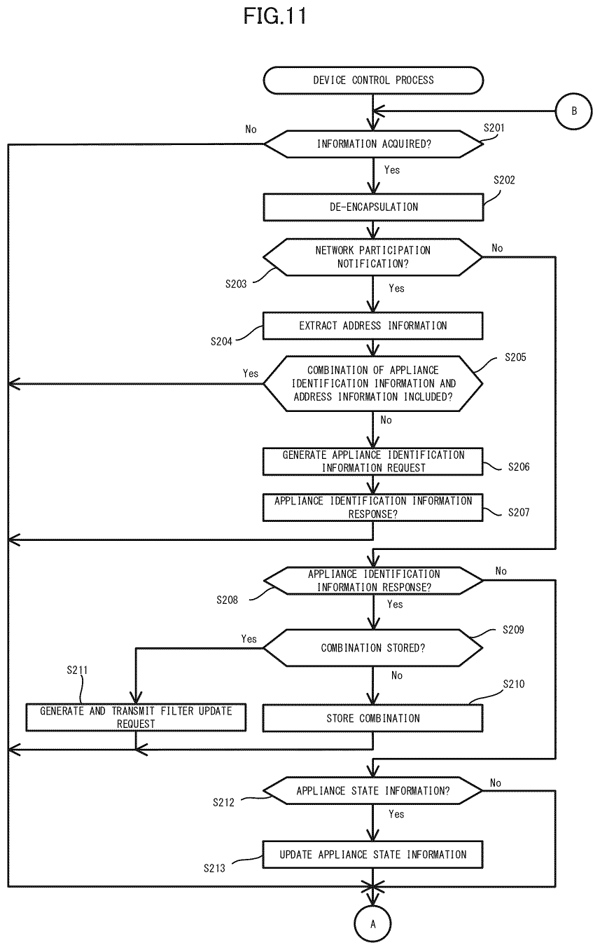

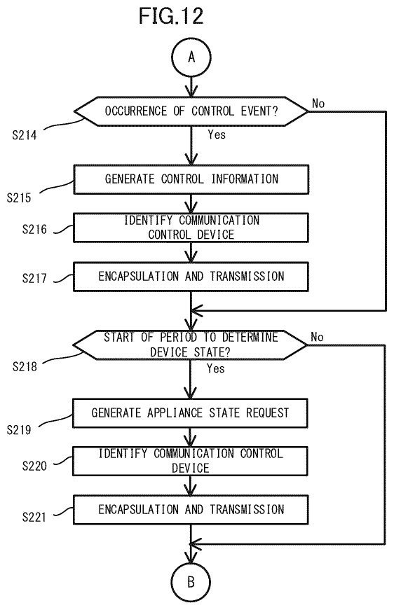

An appliance control process performed by the cloud server 2 according to the present embodiment is now described with reference to FIGS. 11 and 12. This appliance control process starts when, for example, an application to perform the appliance control process is activated in the cloud server 2. The encapsulated-message acquirer 211 first determines whether information transmitted from the communication control device 1A or 1B is acquired (step S201). When the encapsulated-message acquirer 211 determines that the information transmitted from the communication control device 1A or 1B is not acquired (No in step S201), the process in step S214 (described later) is performed. When determining that the information transmitted from the communication control device 1A or 1B is acquired (Yes in step S201), the encapsulated-message acquirer 211 performs de-encapsulation to remove, from the acquired information, the header information specifying the cloud server 2 as a destination (step S202). The message type determiner 212 then determines whether the information with the header information removed is the network participation notification (step S203).

When determining that the information with the header information removed is the network participation notification (Yes in step S203), the message type determiner 212 extracts, from the network participation notification, the MAC address information and the IP address information of the appliance 3, and the MAC address information of the communication control device 1A or 1B (step S204). The combination determiner 213 then determines whether a combination of the extracted IP address information of the appliance 3 and the extracted device identification information of the communication control device 1A or 1B is included in the combinations of IP address information and device identification information stored in the appliance information storage 231 (step S205). When the combination determiner 213 determines that the combination of the extracted IP address information of the appliance 3 and the extracted device identification information of the communication control device 1A or 1B is stored in the appliance information storage 231 (Yes in step S205), the process in step S214 (described later) is performed. When the combination determiner 213 determines that the combination of the extracted IP address information of the appliance 3 and the extracted device identification information of the communication control device 1A or 1B is not included in the combinations of IP address information and device identification information stored in the appliance information storage 231 (No in step S205), the appliance identification information requester 215 generates the appliance identification information request including the extracted MAC address information and the extracted IP address information of the appliance 3 (step S206). The transmission controller 219 then performs encapsulation to add, to the generated appliance identification information request, the header information to specify, as a destination, the communication control device 1A or 1B that is the transmission source of the network participation notification, and transmits the encapsulated appliance identification information request to the communication control device 1A or 1B (step S207). The process in step S214 (described later) is then performed.

When determining that the appliance message with the header information removed is not the network participation notification (No in step S203), the message type determiner 212 determines whether the appliance message with the header information removed is the appliance identification information response (step S208). When the message type determiner 212 determines that the appliance message with the header information removed is the appliance identification information response (Yes in step S208), the combination determiner 213 determines whether the combination of the identification number included in the appliance identification information response and the IP address information and the MAC address information assigned to the appliance 3 that is the transmission source of the appliance identification information response is stored in the appliance information storage 231 in a manner associated with the device identification information of the communication control device 1A or 1B (step S209). When the combination determiner 213 determines that the combination of the identification number and the IP address information and the MAC address information is not stored in the appliance information storage 231 (No in step S209), the appliance information updater 214 causes the appliance information storage 231 to store, in a manner associated with the device identification information of the communication control device 1A or 1B, the combination of the identification number and the type information included in the acquired appliance identification information response and the IP address information and the MAC address information assigned to the appliance 3 that is the transmission source of the appliance identification information response (step S210). The process in step S214 is then performed.

When the combination determiner 213 determines that the combination of the identification number and the IP address information and the MAC address information is stored in the appliance information storage 231 (Yes in step S209), the filter update requester 220 generates the filter update request including the IP address information assigned to the appliance 3 that is the transmission source of the appliance identification information response and included in the acquired appliance identification information response, and transmits the generated filter update request to the communication control device 1A or 1B that is the transmission source of the appliance identification information response (step S211). The process in step S214 is then performed.

When determining that the appliance message with the header information removed is not the appliance identification information response (No in step S208), the message type determiner 212 determines whether the appliance message with the header information removed is the appliance state information (step S212). When the message type determiner 212 determines that information with the header information removed is not the appliance state information (No in step S212), the process in step S214 (described later) is performed. When the message type determiner 212 determines that the information with the header information removed is the appliance state information (Yes in step S212), the state acquirer 216 updates the appliance state information of the appliance 3 stored in the state storage 232 using the appliance state information provided from the message type determiner 212 (step S213).

As illustrated in FIG. 12, the control information generator 217 then refers to the appliance state information stored in the state storage 232 and determines, based on the state of the appliance 3 indicated by the appliance state information, occurrence of the control event for which the control settings of the appliance 3 are to be changed (step S214). When the control information generator 217 determines no occurrence of the control event (No in step S214), the process in step S218 (described later) is performed. When determining the occurrence of the control event (Yes in step S214), the control information generator 217 generates the control information to change the control settings of the appliance 3 (step S215). Subsequently, the transmission controller 219 refers to the device identification information associated with the IP address information of the appliance 3 that is the destination of the appliance state request stored in the appliance information storage 231 to identify the communication control device 1A or 1B that is the transmission source of the control information (step S216). The transmission controller 219 then performs encapsulation to add, to the control information, the header information to specify the identified communication control device 1A or 1B as the destination, and transmits the encapsulated control information to the communication control device 1A or 1B (step S217).

The state acquirer 216 then determines whether the predetermined period to determine the device state starts (step S218). When the state acquirer 216 determines that the period to determine the device state is yet to start (No in step S218), the process in step S201 is performed again. When determining that the period to determine the device state starts (Yes in step S218), the state acquirer 216 generates the appliance state request to request the appliance 3 to transmit the appliance state information (step S219). The transmission controller 219 then refers to the device identification information associated with the IP address information of the appliance 3 that is the destination of the appliance state request stored in the appliance information storage 231 to identify the communication control device 1A or 1B that is the destination (step S220). The transmission controller 219 then performs encapsulation to add, to the appliance state request, the header information to specify the identified communication control device 1A or 1B as the destination, and transmits the encapsulated appliance state request to the communication control device 1A or 1B (step S221). The process in step S201 is then performed again.

When the multiple communication control devices 1A and 1B are connected to the single local area network NW2 and the appliance information storage 231 in the cloud server 2 stores the identification number and the IP address information of the appliance 3 without distinguishing the communication control devices 1A and 1B, the control information for a single appliance 3 is transmitted redundantly to the appliance 3 through both the communication control devices 1A and 1B. When the communication control devices 1A and 1B do not perform the filtering of the appliance message described above, the appliance message (for example, the instance list notification message described above) multicast by the single appliance 3 is transmitted to the cloud server 2 through both the communication control devices 1A and 1B. In other words, the appliance message is transmitted and received redundantly between the communication control devices 1A and 1B and the cloud server 2 by the number of times equal to the number of the communication control devices 1A and 1B, increasing the communication traffic between the communication control devices 1A and 1B and the cloud server 2.

In contrast, in the communication system according to the present embodiment, the appliance information storage 231 stores the identification number and the IP address information of each of the multiple appliances 3 in a manner associated with the device identification information of either the communication control device 1A or the communication control device 1B. Each of the communication control devices 1A and 1B filters, or discards, the appliance message transmitted from an appliance 3 other than appliances 3 allocated to the communication control device 1A or 1B based on the IP address information assigned to the appliance 3 that is the transmission source of the appliance message transmitted to the communication control device 1A or 1B. The appliance message is thus transmitted from the appliance 3 to the cloud server 2 through either the communication control device 1A or the communication control device 1B alone, reducing the likelihood of the same appliance message output to the wide area network NW1 through the communication control devices 1A and 1B, and thus reducing the traffic on the wide area network NW1 accordingly.

In the communication system according to the present embodiment, the transmission determiner 112 filters the appliance message based on the IP address information identifying the appliance 3 that is the transmission source of the appliance message in the network layer. The transmission determiner 112 thus performs no determination of the transmission source of the appliance message in the application layer of the appliance message, reducing the processing load on the communication control devices 1A and 1B accordingly.

The appliance 3 in the present embodiment transmits the network participation notification to the communication control devices 1A and 1B when newly connected to the local area network NW2 or when the IP address information assigned to the appliance 3 is changed. The filtering information is thus updated every time when the appliance 3 is newly connected to the local area network NW2, or when the IP address information assigned to the appliance 3 is changed, appropriately reducing the traffic on the wide area network NW1.

Although one or more embodiments of the present disclosure have been described above, the present disclosure is not limited to the above embodiments. For example, the communication control devices 1A and 1B may each be a gateway having the function of the BBR 8 and connected to the wide area network NW1. The communication system may instead include a communication control device connected to the local area network NW2 and having some of the functions of the communication control devices 1A and 1B described in the embodiment, and a gateway having the remaining functions of the communication control devices 1A and 1B described in the embodiment. Three or more communication control devices may be connected to the local area network NW2.

In the embodiment, the appliance information storage 231 stores the IP address information and the MAC address information of the appliance 3 in a manner associated with the identification number unique to the appliance 3. The appliance information storage 231 may instead store the IP address information and the MAC address information of the appliance 3 in a manner associated with, for example, model information indicating the model of the appliance 3 and a serial number indicating the serial number of the appliance 3.

The functions of the communication control devices 1A and 1B and the cloud server 2 according to one or more embodiments of the present disclosure may be implemented by software, firmware, or a combination of software and firmware. The software or the firmware may be described as a program, and the program may be stored in a non-transitory computer-readable recording medium such as a flexible disk, a compact disk ROM (CD-ROM), a digital versatile disk (DVD), a magneto-optical (MO) disk, or a flash memory for distribution. The program may be read and installed in a computer to allow the computer to implement the above functions. In the system with the above functions implementable partially by the operating system (OS) and applications or through cooperation between the OS and applications, portions other than the OS alone may be stored in a non-transitory recording medium.

Further, programs may be superimposed on a carrier wave to be distributed through a communication network. For example, programs may be posted on a bulletin board system (BBS) on a communication network to be distributed through the network. These programs may be activated and executed under the control of the OS similarly to other application programs to execute the above processing.

### INDUSTRIAL APPLICABILITY

The communication system, the communication control device, the server, the communication control method, and the program according to one or more embodiments of the present disclosure are useful for a control device for a home energy management system (HEMS) installed in a house.

### REFERENCE SIGNS LIST

1A, 1B Communication control device
2 Cloud server
3 Appliance
8 BBR
101,201 CPU
102,202 Main storage
103,203 Auxiliary storage
106,206 Communicator
109, 209 Bus
111 Message acquirer
112 Transmission determiner
113, 219 Transmission controller
114, 211 Encapsulated-message acquirer
115 Message transmitter
116 Filter updater
131 Filter storage
207 Timer
212 Message type determiner
213 Combination determiner
214 Appliance information updater
215 Appliance identification information requester
216 State acquirer
217 Control information generator
220 Filter update requester
231 Appliance information storage
232 State storage
NW1 Wide area network
NW2 Local area network

1. A communication system, comprising:
a server; and
a plurality of communication control devices connected to a local area network to which an appliance is connected and connected to the server through a wide area network, the plurality of communication control devices being configured to transmit, to the server through the wide area network, an appliance message generated by the appliance and acquired through the local area network,
wherein each of the plurality of communication control devices includes
a filter storage to store filtering information to filter the appliance message for transmission to the server based on appliance identification information identifying the appliance being a transmission source of the appliance message, and
first processing circuitry
to update the filtering information based on a filter update request transmitted from the server to request an update of the filtering information,
to acquire the appliance message transmitted from the appliance, and
to determine whether to transmit the appliance message to the server based on the filtering information, and
the server includes
an appliance information storage to store, in a manner associated with each other, the appliance identification information and device identification information identifying a communication control device of the plurality of communication control devices, and
second processing circuitry
to determine whether the appliance information storage stores a combination of the appliance identification information included in the appliance message and transmitted from one communication control device of the plurality of communication control devices and the device identification information of the one communication control device being a transmission source of the appliance message,
to cause the appliance information storage to newly store first appliance identification information included in the combination determined as not being stored in the appliance information storage in a manner associated with the device identification information of a transmission source of a first appliance message including the first appliance identification information, and
to transmit, to a communication control device of the plurality of communication control devices being a transmission source of a second appliance message, a filter update request to request an update of the filtering information to filter the second appliance message including second appliance identification information included in the combination determined as being stored in the appliance information storage.

2. The communication system according to claim 1, wherein
the device identification information identifies the appliance being the transmission source of the appliance message in a network layer.

3. The communication system according to claim 1, wherein
the appliance transmits the appliance message including the appliance identification information to the plurality of communication control devices when the appliance is newly connected to the local area network or when the appliance identification information provided to the appliance is changed.

4. A communication control device connected to a local area network to which an appliance is connected and connected to a server through a wide area network, the communication control device being a device for transmitting an appliance message generated by the appliance and acquired through the local area network to the server through the wide area network, the communication control device comprising:
a filter storage to store filtering information to filter the appliance message for transmission to the server based on appliance identification information identifying the appliance being a transmission source of the appliance message, the appliance identification information including appliance identification information of the appliance having sent the appliance message via another communication control device to the server; and
first processing circuitry
to update the filtering information based on a filter update request transmitted from the server to request an update of the filtering information,
to acquire the appliance message transmitted from the appliance, and
in response to acquisition of the appliance message, to determine, based on the filtering information, to send the appliance message to the server when the appliance message is not sent via the another communication control device before the acquisition of the appliance message by the appliance that is the transmission source of the appliance message, and to determine, based on the filtering information, to discard the appliance message when the appliance message is sent via the another communication control device to the server before the acquisition of the appliance message by the appliance that is the transmission source of the appliance message.

5. A server connected, through a wide area network, to a plurality of communication control devices connected to a local area network to which an appliance is connected, the server being a server for acquiring, from a communication control device of the plurality of communication control devices through the wide area network, an appliance message generated by the appliance and acquired through the local area network, the server comprising:
second processing circuitry
to store, in a manner associated with each other, appliance identification information identifying the appliance and device identification information identifying a communication control device of the plurality of communication control devices,
to determine whether the appliance information storage stores a combination of the appliance identification information included in the appliance message transmitted from one communication control device of the plurality of communication control devices and the device identification information of the one communication control device being a transmission source of the appliance message,
to cause the appliance information storage to newly store first appliance identification information included in the combination determined as not being stored in the appliance information storage in a manner associated with the device identification information of a transmission source of a first appliance message including the first appliance identification information, and
to transmit, to a communication control device of the plurality of communication control devices being a transmission source of a second appliance message, a filter update request to request an update of filtering information to filter the second appliance message in the communication control device being the transmission source of the second appliance message including second appliance identification information included in the combination determined as being stored in the appliance information storage.

6. A communication control method implementable with a server and a plurality of communication control devices connected to a local area network to which an appliance is connected and connected to the server through a wide area network to transmit, to the server through the wide area network, an appliance message generated by the appliance and acquired through the local area network, the method comprising:
updating, by each of the plurality of communication control devices, filtering information stored in a filter storage to filter the appliance message for transmission to the server based on appliance identification information identifying the appliance being a transmission source of the appliance message, the updating being performed based on a filter update request to request an update of the filtering information transmitted from the server;
acquiring, by each of the plurality of communication control devices, the appliance message transmitted from the appliance;
determining, by each of the plurality of communication control devices, whether to transmit the appliance message to the server based on the filtering information;
determining, by the server, whether an appliance information storage storing, in a manner associated with each other, the appliance identification information and device identification information identifying a communication control device of the plurality of communication control devices stores a combination of the appliance identification information included in the appliance message and transmitted from one communication control device of the plurality of communication control devices and the device identification information of the one communication control device being a transmission source of the appliance message;
causing the appliance information storage to newly store first appliance identification information included in the combination determined as not being stored in the appliance information storage in a manner associated with the device identification information of a transmission source of a first appliance message including the first appliance identification information; and
transmitting, to a communication control device of the plurality of communication control devices being a transmission source of a second appliance message, a filter update request to request an update of the filtering information to filter the second appliance message including second appliance identification information included in the combination determined as being stored in the appliance information storage.

7. A non-transitory computer-readable recording medium storing a program, the program causing a computer to execute instructions comprising:
updating filtering information stored in a filter storage to filter, based on appliance identification information identifying an appliance being a transmission source of an appliance message generated by the appliance and acquired through a local area network to which the appliance is connected, the appliance message for transmission to a server through a wide area network to which the server is connected, the appliance identification information including appliance identification information of the appliance having sent the appliance message via another communication control device to a server, the filter updater being configured to update the filtering information based on a filter update request transmitted from the server to request an update of the filtering information;
acquiring the appliance message transmitted from the appliance; and
in response to acquisition of the appliance message, determining, based on the filtering information, to send the appliance message to the server when the appliance message is not sent via the another communication control device before the acquisition of the appliance message by the appliance that is the transmission source of the appliance message, and determining, based on the filtering information, to discard the appliance message when the appliance message is sent via the another communication control device to the server before the acquisition of the appliance message by the appliance that is the transmission source of the appliance message.

8. A non-transitory computer-readable recording medium storing a program, the program causing a computer to execute instructions comprising:
determining whether an appliance information storage to store, in a manner associated with each other, appliance identification information identifying an appliance and device identification information identifying a communication control device of a plurality of communication control devices connected to the appliance through a local area network stores a combination of the appliance identification information included in an appliance message transmitted from one communication control device of the plurality of communication control devices through a wide area network to which the plurality of communication control devices are connected and the device identification information of the one communication control device being a transmission source of the appliance message;
causing the appliance information storage to newly store first appliance identification information included in the combination determined as not being stored in the appliance information storage in a manner associated with the device identification information of a transmission source of a first appliance message including the first appliance identification information; and
transmitting, to a communication control device of the plurality of communication control devices being a transmission source of a second appliance message, a filter update request to request an update of filtering information to filter the second appliance message in the communication control device being the transmission source of the second appliance message including second appliance identification information included in the combination determined as being stored in the appliance information storage.

9. The communication system according to claim 2, wherein
the appliance transmits the appliance message including the appliance identification information to the plurality of communication control devices when the appliance is newly connected to the local area network or when the appliance identification information provided to the appliance is changed.
